(19) United States
(12) Patent Application Publication
(10) Pub. No.: US 2002/0152284 A1
(43) Pub. Date: Oct. 17, 2002

(54) System and method for performing real time monitoring and control of an interactive network

(76) Inventors: John Cambray, Pelham, NH (US); Paul Edwards, Manchester, NH (US); Michael McLaughlin, Merrimack, NH (US); George Melillo, Pepperell, MA (US); B. Scott Smith, Londonderry, NH (US); Robert J. Stent, Westford, MA (US)

Correspondence Address: BOURQUE & ASSOCIATES, P.A., Suite 303, 835 Hanover Street, Manchester, NH, 03104, US

(21) Appl. No.: 09/835,112

(22) Filed: Apr. 13, 2001

(51) Int. Cl. G06F 15/173; G06F 15/16

(52) U.S. Cl. 709/218; 709/217; 709/224

(57) ABSTRACT

A system and method for performing real time monitoring of an interactive network server, such as a web site server, provides for receiving requests for information from at least one visitor and in response to providing the information to the visitor, reports information concerning the visitor's activities on the server, including a visitor identifier and information requested or provided to the visitor. The visitor information is filtered and organized for determining at least the present status of the visitor presently accessing the network server, in real time. A data analyzer organizes raw the visitor information and provides the organized information to a data accumulator which further organizes the information into a higher level for display, in graphical format, to a user. The user may display at least the status of each visitor presently accessing the network server, including track history and purchase information and allows display of that information in real time and in a graphical format to a network server administrator. In response to user input on a network server administrative terminal, an information control signal may be sent back to the interactive network server to control what information is displayed to the visitor presently accessing the interactive network server.

### TECHNICAL FIELD

The present invention relates to a method and apparatus for monitoring and reporting on the activity of users on an interactive network server and in one particular embodiment, for monitoring and displaying real time, useful statistics regarding web site visitors' movements and activities on a web site, thereby allowing the web site manager to improve the visitors use and enjoyment of the web site and ultimately the results of activities on the web site server by controlling the information provided to the visitor as well as the behavior and characteristics of the web site server.

### BACKGROUND OF THE INVENTION

Network servers are commonly used in networked systems to provide services and functions and access to data and programs to network users. It is a common desire to monitor and manage activities in the network servers to provide optimum and correct performance of the servers.

Network servers may take many forms. For purposes of the following discussions, two of the most common forms of network servers may be defined as file servers and interactive servers. A typical file server, for example, provides copies of information to users, such as data or programs, while an example of an interactive network server is an Internet web site server. It will be appreciated that these two forms of network servers have significantly different characteristics, due to the differing functions and operations supported by each, and therefore present significantly different problems in monitoring and managing the activities of the servers.

A file server, for example, may be characterized as a single path, request/response system wherein each transaction between a user and a file server is typically comprised of a single request/response operation. That is, in a typical user/server transaction on a file server, a user submits a request, for example, for a data item, which may be a file or portion of a file, and the file server responds by providing the requested data item to the user. Since each file is essentially treated as a separate and independent entity from all other files in the server, each request for a file or portion of a file is executed as a separate and independent transaction.

As such, a user request identifying a plurality of data items is thereby typically executed as a series of independent transactions, one for each identified data item. For these reasons, each transaction essentially follows a single, fixed path of operations through the file server from the user input to the requested file and from the requested file to the user. As a consequence, each user/server transaction is comprised of a known, fixed sequence of operations with only a few, well defined possible variations. As a result of these characteristics, and even though most file servers are capable of handling multiple concurrent requests from a plurality of users, it is a relatively simple matter to track each request/response transaction and the component steps or actions of each request/response transaction and to monitor the activities of the file server, and to manage, adjust or adapt the operations of a file server for optimum performance.

In contrast, interactive network servers may be characterized as multiple path, multiple request/response systems wherein each user/server transaction is typically comprised of a series of request/response interactions in which the number, sequence and type of requests and responses comprising each ultimate transaction is variable. In particular, the specific requests and sequence of requests comprising a single transaction and the corresponding responses are typically selectable only by the user and are dependent upon the operations or results desired by the user.

The data residing on an interactive network server or the functions and operations supported by an interactive network server are typically interrelated or interdependent and define a matrix of request/response paths through the server. As such, a given request and corresponding response is generally dependent upon one or more preceding requests and responses and upon the data item or operation accessed at each request.

A typical web site server, for example, is presented to a user as an interrelated structure of HTML coded pages (commonly called Web Pages, although HTML coded pages is not a limitation of the present invention) containing, for example, links to data items, functions and operations, fields for data entry by the user, links to other web pages, and so on. These HTML pages can be either previously generated or can be dynamically generated by the server based on various criterion including where the user has traveled while on the site as well as other criterion.

Any given user (visitor) to the Web Site may thereby navigate a path of the user's own choosing through the web pages, functions and data items of the site by the choice of a desired request at each possible branching of the possible paths through the site. Accordingly, the number of possible paths through an interactive file server is generally very large and very complex and generally differs significantly for each user/server interaction.

The possible sequences of request/response interactions will thereby vary according to each user/system transaction, even if the number of different possible requests is relatively small, and, as a consequence, the monitoring of the activities and performance of an interactive server is correspondingly complex.

The problem is compounded in that a typical interactive server, such as a web site server, is required to handle a plurality of user transactions concurrently, and segments of concurrent transactions or entire transactions may be similar or even identical to those of other users and may overlap in time.

The problem is compounded still further in that the requests from different concurrent users may be received by the server at any time and in any order between the users, and the requests from a given user may be received by the server out of order because of varying transmission delays through the network.

As such, it is extremely difficult to track a given transaction through an interactive network server on an visitor by visitor basis, to relate a given interaction to a specific user or visitor, or even to distinguish between interactions of two or more visitors, particularly if the tracking or execution of one or more transactions are interrupted or if the beginning of a given transaction is missed for any reason.

One problem with the prior art interactive network servers, such as Web Servers, is the inability to monitor, in real time, the present activities of each visitor to the site to be sure that the visitor has easy access to the information he or she wants in the hopes that the visitor will easily find and purchase (in the case of a sales web site) the products that the visitor desires. Further, some web servers can dynamically generate web pages specifically for a given visitor.

One primary method of the prior art for monitoring the activity of an interactive server such as a web site server is the use of log files to record internal operations and interactions executed by the web site server. Log files have proven unsatisfactory for several reasons including the fact that a review of log files yields, at best, only past, historical information. Further, as discussed above, it is extremely difficult to track a given transaction (visitor interaction) through an interactive server on a visitor-by-visitor basis by simply monitoring the individual interactions and operations of the server.

In particular, the events of a transaction as recorded in a conventional log file are “flat”, that is, typically appear as individual, isolated operations or actions and do not usefully represent the interrelationships between operations and activities of an interactive file server in such a manner as to represent or relate to a given user/server transaction. As a result, a log file system typically monitors and tabulates the individual operations of a web site server to provide statistical information, such as how many of what type of operations or interactions were performed during a given period, but is typically unable to identify the specific sequence of operations and interactions comprising a given transaction.

In addition, and for the same reasons, a log file system is typically unable to provide “real time” information regarding ongoing transactions in the server because a log file typically records individual operations and interactions, rather than transactions as entities. The current practice, therefore, is to periodically evaluate the log files and determine summaries over a predetermined period of time, such as the past hour, the past day, the past week, the past month, and so on. However, none of the systems currently available are able to provide a system administrator with real time information to facilitate system administration and therefore visitor satisfaction and sales conversions on a real time basis. As a consequence, a system administrator is unable to monitor current transactions on an individual basis to insure that users of the system obtain the necessary results or help in a timely manner. It is also extremely difficult to identify a specific problem area in a server, such as a broken or confusing link.

Another method of prior art monitoring of the activity of an interactive server is traffic monitoring, which is the recording of requests and responses into and out of the site through the network. This method, however, suffers from the same problems as the log file method and, again, the method typically provides only historical summary information regarding network traffic over the last hour, day, week, month, and so on, and is typically not able to provide information regarding a specific transaction or to identify a specific problem area in the server.

### SUMMARY OF THE INVENTION

The present invention features a system for performing real time monitoring of activities on an interactive network server, such as a web server. The system includes an interactive network server including a source of information, such as a number of web pages; an information controller such as a web server; and a server activity reporter such as an API or a log file.

The interactive network server is coupled to a computer network, such as the World Wide Web, for receiving requests for at least a first amount of information (such as a web page request) from at least one visitor accessing the interactive network server. Responsive to the visitor requests, the network server provides the requested information from the source of information to the visitor over the computer network.

The information controller controls the providing of the information to a visitor, while the server activity reporter provides an indication of at least some of said activities of one or more visitors on the interactive network server.

A data filter, which is responsive to the interactive network server activity reporter, is provided to filter at least some of said interactive network server activity information and for providing filtered interactive network server activity information.

A data analyzer, which is responsive to the filtered interactive network server activity information, is provided for determining at least the present status of the one or more visitors accessing the interactive network server.

The system of the present invention also includes a data reporter, which is responsive to the data analyzer and to a request for visitor information, for organizing and preparing for display, in a graphical format, at least the present status of the one or more visitors accessing the interactive network server.

Also provided is at least one network server administrative terminal including a data display device such as a CRT and a data input device such as a mouse and keyboard, the network server administrative terminal provides requests for specific visitor information to the data reporter, and responsive to highly filtered and organized information received from the data reporter, displays, on the data display device in real time graphical format, the requested information which typically includes at least the present status of one or more visitors on the server as well as visitor purchase activity, such as shopping cart activity.

### BRIEF DESCRIPTION OF THE DRAWINGS

These and other features and advantages of the present invention will be better understood by reading the following detailed description, taken together with the drawings wherein:

FIG. 1 is a functional block diagram of the system for performing real time monitoring and reporting of an interactive network server according to the present invention;

FIG. 2 is a more detailed block diagram of one embodiment of a system for performing real time monitoring and control of an interactive network server of the present invention;

FIG. 3 is a schematic representation of a log file in accordance with one feature of the present invention;

FIG. 4 is a schematic representation of a chart illustrating some event generator generated events and their relationship to one another;

FIG. 5 is a schematic illustration of a first scan type in accordance with one feature of the present invention;

FIG. 6 is a chart that illustrates the conversion of low level raw information from a web server into “events” by the event generator which forms part of the present invention;

FIG. 7 is a schematic illustration of a visitor path created by the event distributor which forms part of the present invention;

FIG. 8 is a representation of a web server hierarchical chart received and stored by the present invention;

FIG. 9 is a schematic illustration of a parent category/subcategory tree utilized by the data accumulator of the present invention;

FIG. 10 is a schematic illustration of a more detailed parent category/subcategory tree;

FIG. 11 is a schematic illustration of a real time display of visitor activity generated by the present invention;

FIG. 12 is a more detailed view of one of the visitor displays of FIG. 11 illustrating the most detailed level of visitor activity;

FIG. 13a schematic illustration of another real time display generated by the present invention;

FIG. 14 is a schematic illustration of yet another real time display generated by the present invention in the form of a pie chart showing visitor information by category;

FIG. 15 is a schematic illustration of a real time of the data displayed by FIG. 14 wherein the user has drilled down for further detail;

FIG. 16 is a schematic illustration of a real time of the data displayed by FIG. 15 wherein the user has requested further detail;

FIG. 17 is a schematic illustration of a real time of the data displayed by FIG. 16 wherein the user has requested yet further detail;

FIG. 18 is a schematic illustration of a real time of the data displayed by FIG. 17 wherein the user has requested yet further detail; and

FIG. 19 is a schematic illustration of a real time data display showing visitor flow between categories as well as visitor cart data as generated by the present invention.

### DETAILED DESCRIPTION OF THE PREFERRED EMBODIMENTS

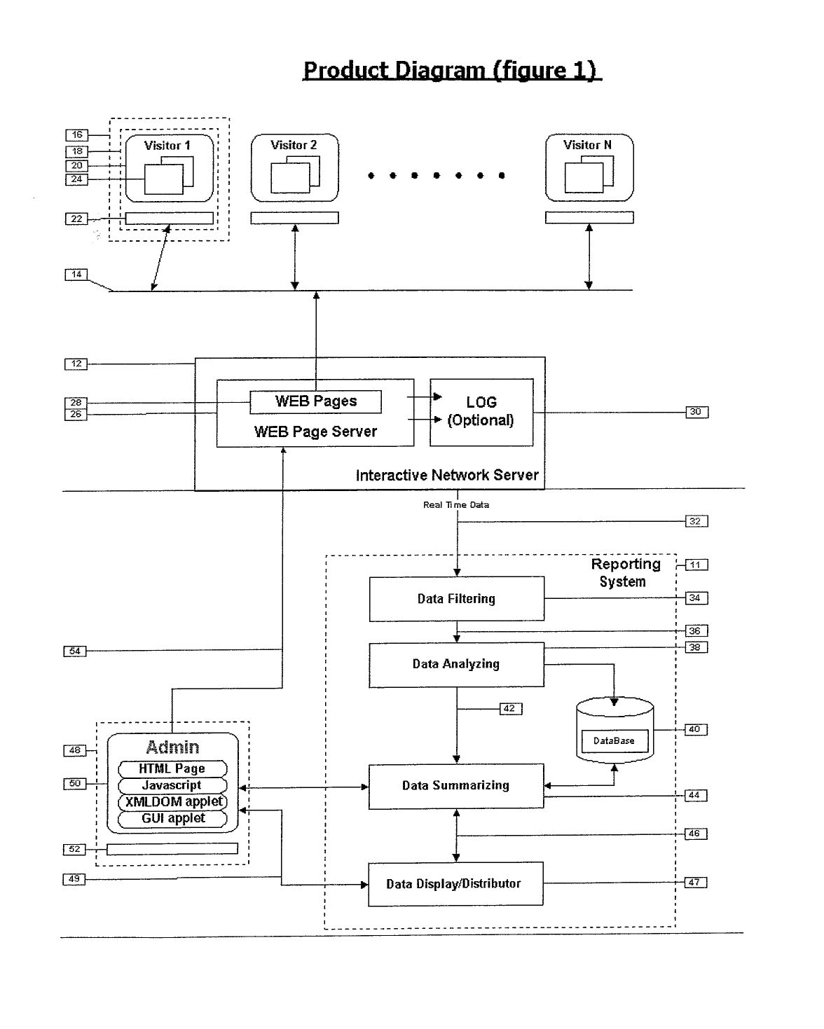

In accordance with the teachings of the present invention, the system 10, FIG. 1, on which can be implemented the real time monitoring and reporting system 11 of an interactive network server 12 is shown in a functional block diagram. The system 10 includes an interactive network server in the form of a web server 12 coupled to a computer network 14, such as the World-Wide-Web, through which one or more visitors 16 may access the web server 12. Although the present invention will be explained in connection with an interactive network server in the form of a web server connected to a computer network in the form of a World-Wide-Web, this is not a limitation of the present invention but, rather, is shown for exemplary purposes only.

As shown in the present embodiment, each visitor 16 accesses the World-Wide-Web 14 using a data terminal 18 comprising a display monitor 20 and keyboard and/or other input device 22 connected to a central processing unit, not shown, such as, for example, a personal computer. No further explanation of such a system is required as such information is within the knowledge of someone with ordinary skill in the art.

In the preferred embodiment, each visitor terminal display monitor 20 is adapted to display one or more web pages 24 retrieved from the web server 12.

Web server 12 includes a web page server 26 which is an application process which controls the providing of one or more web pages from typically a large number of web pages 28 which are stored on the web serverl2, via the World-Wide-Web 14 to one or more visitors 18. The web pages 28 on the web server 12 may be previously generated or, in one embodiment, dynamically generated by the web server 26, under control of signal 54 from an administrator terminal 48, specifically for a visitor based on the visitor's prior web page track or history during a given session on the web server or based on the administrator's review and monitoring of this or other visitor's activities on the web server 12.

In accordance with one embodiment of the present invention, a system for real time monitoring and reporting 11 may include a server log 30 which serves to record information about the visitors which access the web server 12 and their activities on the server, including a unique identifier for each visitor, and whether another web site referred this visitor to the present web site, and the various web pages which a given visitor has accessed as will be explained in greater detail below.

In the preferred implementation, a system log is not required but rather, may be implemented utilizing an API that sends the raw data concerning web activity directly from the web server to the event generator.

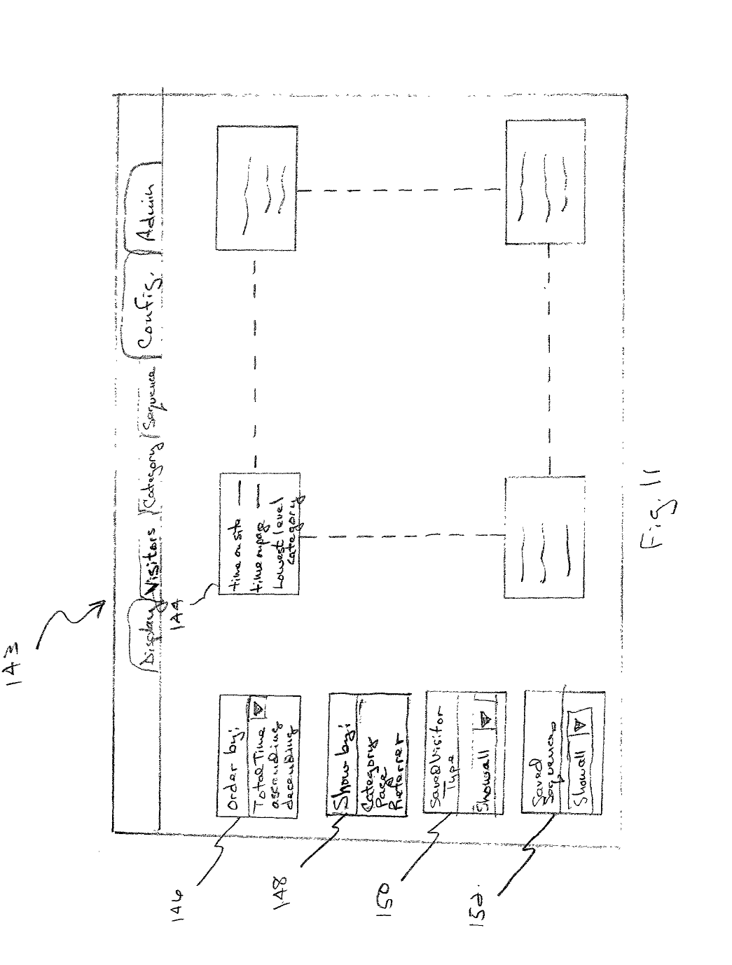

In the case wherein there is a log file maintained, the log 30 is kept in real time and therefore, the real time log data 32 or raw real time data, in the case of no log file, is provided to a data filtering system 34 which analyzes the data for information which the user has defined as being of interest and processes those entries. In the preferred embodiment, the data filter formats data to be output as “events” (see FIG. 11).

Events are web server transactions of interest such as the arrival of a visitor at a web site, the request for a page by said visitor, or the creation or a web store shopping cart, etc. The data filtering system 34 may receive as input a configuration file which tells it where to look for the optional log file, and, which records in the log file to ignore, such as a request for an image, and where the results of the data filtering will be provided. Further details of the data filtering system are provided below.

The filtered data 36, presented as low level information, is provided to a data analyzing system 38 which includes an event generator which receives the information of interest 36 and generates “events” from which visitor trails, sequences or paths which the visitor pursued while on the Web site 12 can later be put assembled. The data analyzer also creates associations between user trails and cart information. In this way, a history of the visitor's transactions with the web server can be recreated, and in addition, the visitor's present location and status on the web server can be ascertained. The results 42 of the data analyzer 38 may be stored in an event database 40 for later access and retrieval.

Ultimately, the results 42 of the data analyzing system 38 will be provided to a data summarizing system 44. The data summarizing system is adapted to formulate the results 42 of the visitor and cart information into graphically displayable and useful information which is provided over signal path 46 to the data display system 47. The data display system 47 receives user input over signal path 49 from one or more administrator terminals 48 including a display monitor 50 and user input device such as a keyboard or other similar device 52 regarding what data to report, how to format the data, and how to report the data. The data will then be displayed to the administrator terminal 48.

After reviewing the formatted and displayed information received over signal path 49 provided by the data display system 47, an administrator at the administrator computer 48 may provide input to the web page server 26 over signal path 54 to direct and/or dynamically change or alter the information on the web server 12 which a particular visitor will see as he or she requests additional information or further interacts with the interactive web server 12.

Although the log 30, in accordance with one feature of the present invention, is shown in connection with the interactive network server 12, this is not a limitation of the present invention as the log feature and function may be located external to the web server 12.

In addition, although the data filtering system 34; data analyzing system 38; data summarizing system 44; and data display system 47 are shown as separate entities, this is also not a limitation of the present invention as they may all be combined on one external server (computer); located as part of the web server 12; or located on the administrative computer 48.

The preferred embodiment contemplates that the data filtering system 34; the data analyzing system 38; the data summarizing system 44 and data display system 47 will be implemented as software processes running on a server (computer) external from the web server 12, although this is not a limitation of the present invention.

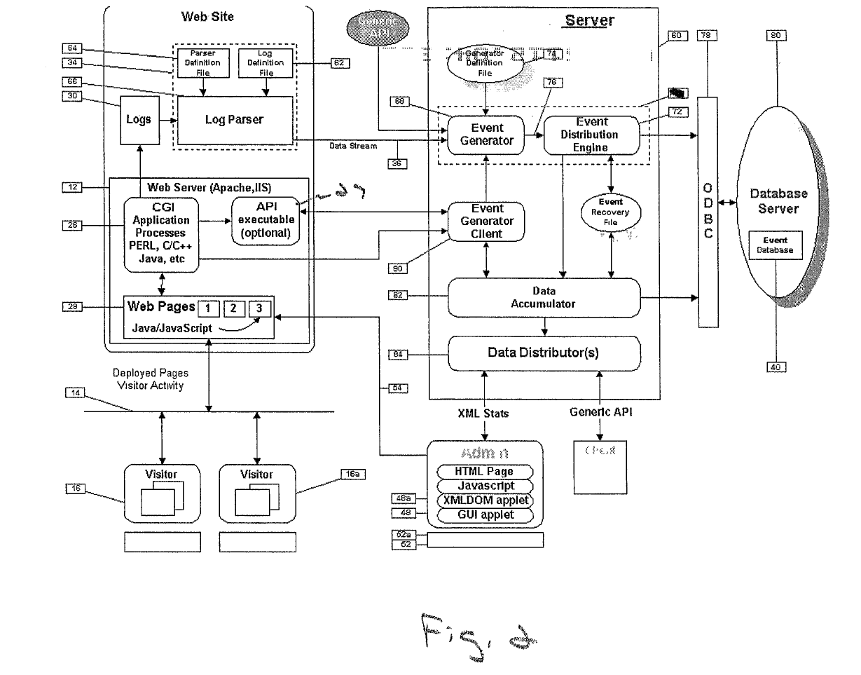

In accordance with one implementation of the present invention, a system 10a, FIG. 2, for implementing real time monitoring and reporting of an interactive network server is shown in greater detail. In this exemplary embodiment, the system 10a includes two servers: the first, the interactive network server implemented in terms of a web server 12 and the second, a system server 60 which incorporates the data filtering system 34 of FIG. 1 as an event generator 68; the data analyzing system 38 of FIG. 1 as an Event distribution Engine 72; the data summarizing system 44 of FIG. 1 as a Data Accumulator 82; and the data display system 47 of FIG. 1 as a Data Distributor 84, all in accordance with the teachings of the present invention.

In one implementation wherein a log file is utilized, a data parsing system 34 is implemented on the web server 12, although the physical location of the implementation of the data parsing system 34 is not a limitation of the present invention.

As previously discussed, the web server 12 includes, among other application processes, a web server process 26 which controls the display of one or more web pages 28 to one or more visitors 16 accessing the web server via the World-Wide-Web or other computer network 14. The web page server 26 or other application process generates the information necessary to enter into the log file 30. The log file 30, a log definition file 62, and the parsing system definition file 64 all serve as input to parser 66 which is used to select the information of interest required and defined by the user in the parser definition file 64.

The parser definition or configuration file 64 provides information to the parser 66 such as, for example only, the definition of the host name of the server where the event generator 68 program executes; the definition of the software port that the event generator 68 will use for connections with the log parser; the name of the log definition file which will be interrogated for the definition of the log file format; the definition of the records to be ignored to speed up processing, for example, .gif, .jpg and jpeg files; and identification of specific records, if any, which are to be processed which may be useful if the user wishes to define only certain entries which will be processed.

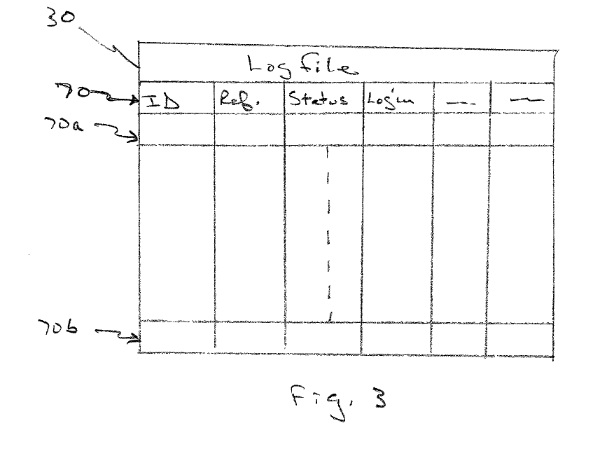

A schematic representation of a log file 30, FIG. 3, includes one or more entries 70, each entry 70 pertaining to one access of information for a given visitor. Each entry includes information such as a unique visitor identifier which may be, for example, the visitor's IP address; information related to the referral source of the visitor, the present status of the visitor; the log-in of the user, if applicable; the URL or page requested by the user; any information the user input into the system; and other similar parameters.

Once the log information 30 has been parsed by the log parser 66, if utilized, the parsed log information 36 is provided to an event generator 68 which serves as the filtering system.

In the preferred embodiment, the present invention contemplates the addition of an API 27 on the web server 12, whose function is to access the web server's application processes 26 and monitor those processes 26 to provide low level web activity information such as client connects to the web server, pages visited by customers, and the URL of pages requested, etc. to the event generator 68. In addition, if the system utilizes a log file, the API 27 will send cart information to the Event generator client 90.

The Event Generator client 90 may also interrogate the API 27 to inquire about cart status if the data accumulator is utilizing a trigger as described below.

The event generator 68 analyzes each information record 36 and generates a stream or series of events 76 to the event distribution engine 72 which will further analyze the events. The event generator definition file 74 defines the type and content of these events for the event generator 68.

The event generator 68 is responsible for the majority of the events that provide information reflecting the transactions on the web server 12 or another application server the event generator 68 is preferably implemented as a CORBA server such as omniORB from AT&T.

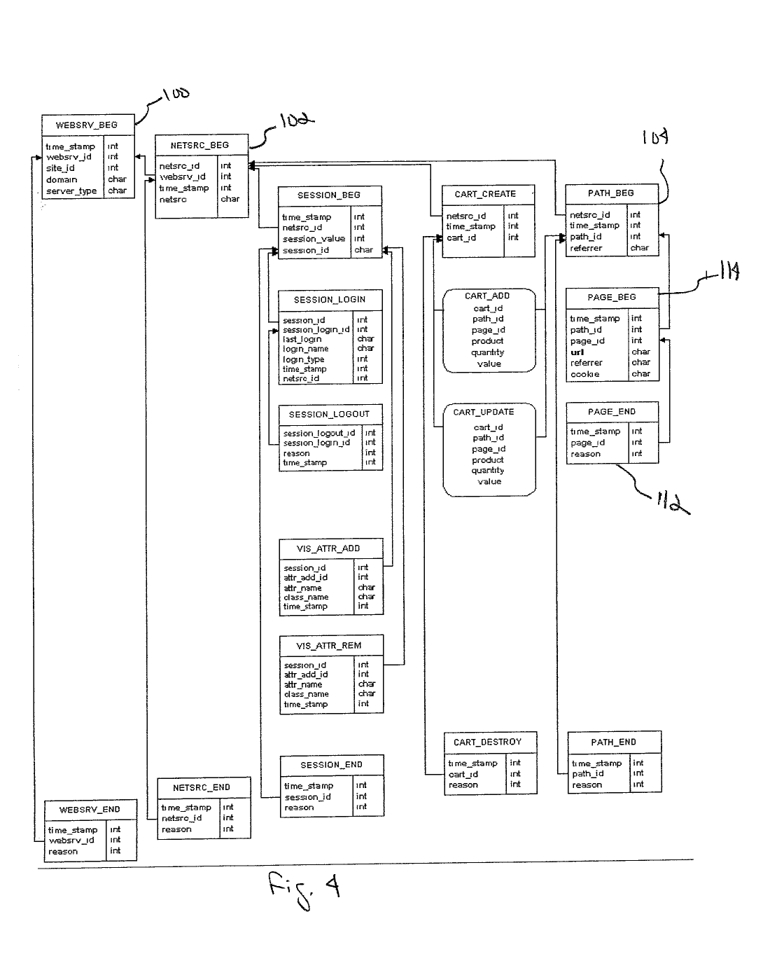

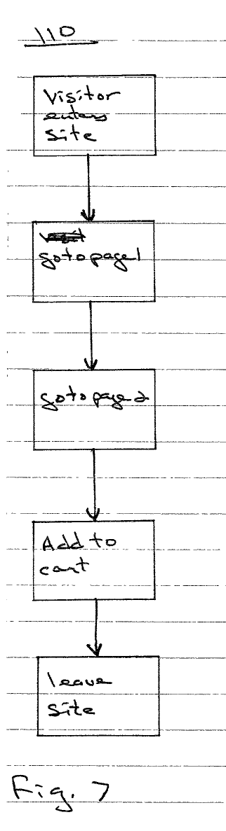

The event generator 68 should receive a srvName( ) request 107, FIG. 6, as the first request from a newly established connection that serves as a description for the connection. When such a request is received, a WEBSRV_BEG event 100, FIGS. 4 and 6, is generated by the event generator 68.

The event generator 68 will receive a newpage( ) request whenever a client wishes to provide information about a visitor requesting a web server page. A web server request can be a request for a text page, an image, an audio file or a script. Accordingly, a page request can be generated on behalf of any request that the web server might wish to log.

The web server 12 does not receive information each and every time a visitor visits a web page associated with the web site. This is because the visitor's browser may be configured to maintain the web page in cache. This could also be because proxy servers along the way have cached the page memory. Because of this, the event generator 68 must make intuitive guesses as to the path the visitor is taking based on various parameters of the request.

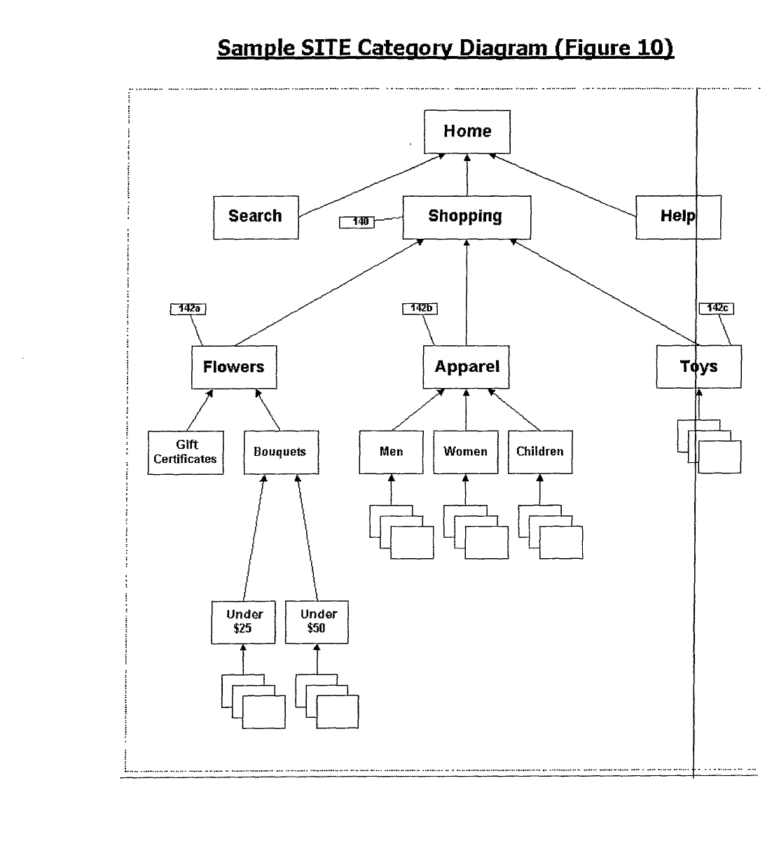

For example, when a newpage( ) request 109, FIG. 9, is received, the event generator 68 must determine if it has any knowledge of the network source associated with the request. The event generator 68 attempts to find an instance of the network source by performing a lookup based on the cookie in the loggerPage structure. Failing to find a matching network source by the cookie, an attempt will be made to find a matching network source by the IP address or the host name. If the event generator 68 still cannot find a matching network source, it will create a new one. A list of network sources is maintained dynamically within the event generator 68. If the event generator needs to create a network source to service the new page, it will generate a NETSRC_Beg event 102.

Once a network source is obtained, the page must be associated with a path. A network source has a list of paths that the visitor has taken. The list of paths is traversed by the event generator 68 to determine if the page belongs to a previously defined path for the network source.

A path is a list of pages maintained by the event generator 68. Each path has a current page pointer element that points to a certain page of the path. The current page pointer may move up or down the path of pages depending upon the page requests that the visitor generates.

If no list of paths exists for a network source associated with the current page request because it is a newly created network source, then a new path will be created. If a new path is created, a PATH_BEG event 104 is generated.

If a list of paths exists, then the paths are traversed in an attempt to determine where the page might belong within a path. Each path in the list is scanned to determine if the page request fits somewhere in the path.

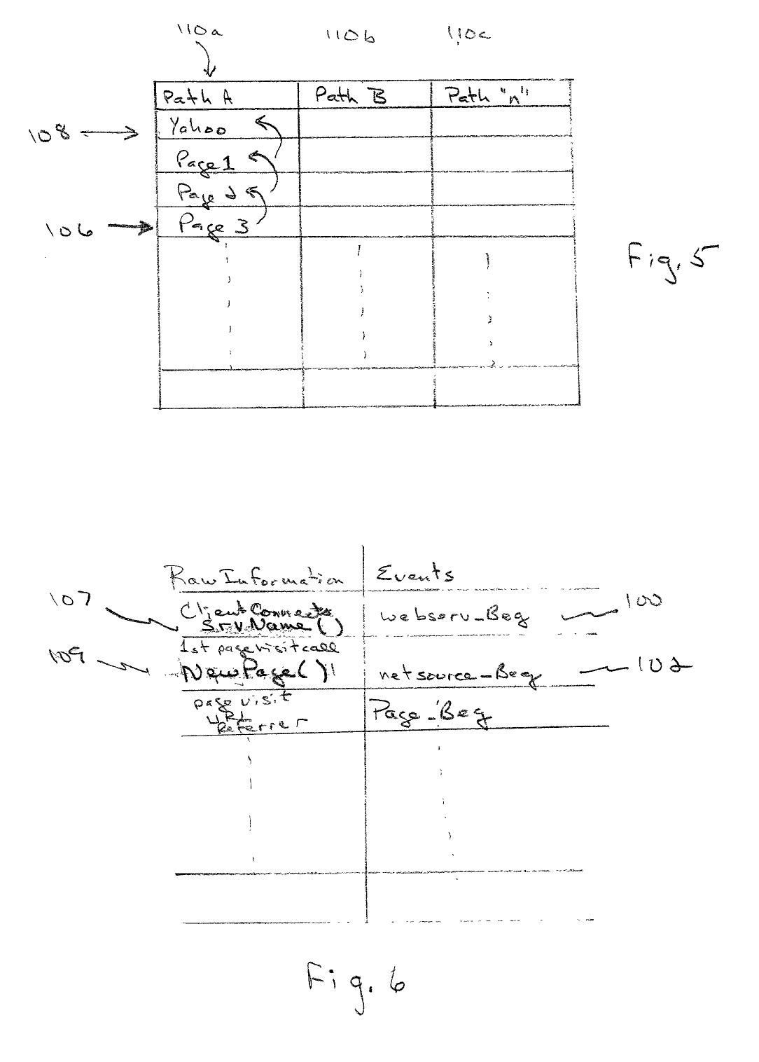

The first scan type of a path starts from the current page pointer location 106, FIG. 5, and scans backwards toward the beginning of the list 108 for an occurrence of a page that matches both the URL and the referrer of the new request. If the page is found in the path 110, then a series of PAGE_END events 112, FIG. 4, and PAGE_BEG 114 events are generated until the page in the path 110 becomes active. The active page is the page with the last PAGE BEG event generated that does not have an associated PAGE END event.

For example, for a new request: URL=b, referrer=a Current path:

page 1: URL=a, referrer=www.yahoo.com

page 2: URL=b, referrer=a

page 3: URL=c, referrer=b

page 4: URL=d, referrer=c←current page pointer

page 5: URL=e, referrer=d

In this scenario, the page pointer is not at the bottom of the path. The current active page for this path is page 4. The event generator 68 will find a match for the current request at page 2 of the path, so the following set of events will be generated:

PAGE_END page 4

PAGE_BEG page 3

PAGE_END page 3

PAGE_BEG page 2

A current page pointer will be reset to point to page 2. Scanning stops once a match is found.

The second scan type of a path starts at the current page pointer location and scans forward until the end of the list for an occurrence of a page that matches both the URL and the referrer of the new request. If the page is found in the path, then a series of PAGE END and PAGE BEG events are generated until the page in the path is active.

For example, for a new request: URL=e, referrer=d Current path:

page 1: URL=a, referrer=www.yahoo.com

page 2: URL=b, referrer=a

page 3: URL=c, referrer=b

page 4: URL=d, referrer=c←current page pointer

page 5: URL=e, referrer=d

In this scenario, the page pointer is not at the bottom of the path. The current active page for this path is page 4. The event generator 68 will find a match for the current request at page 5 of the path. Accordingly, the following set of events will be generated:

PAGE_END page 4

PAGE_BEG page 5

The current page pointer would be reset to point to page 5. Scanning stops once a match is found.

The third scan type of a path starts from the current page pointer location and scans backwards toward the beginning of the list for an occurrence of a URL that matches the new requests referrer. If the page is found in the path, then a series of PAGE_END and PAGE BEG events are generated until the page in the path is active. Then the found page is deactivated with a PAGE_END event and a new page is activated with a PAGE_BEG event.

For the new request: URL=f, referrer=b Current path:

page 1: URL=a, referrer=www.yahoo.com

page 2: URL=b, referrer=a

page 3: URL=c, referrer=b

page 4: URL=d, referrer=c←current page pointer

page 5: URL=e, referrer=d

In this scenario, the page pointer is not at the bottom of the path. The current active page for this path is page 4. The event generator 68 will find a match for the referrer at page 2 of the path. Accordingly, the following set of events will be generated:

PAGE_END page 4

PAGE_BEG page 3

PAGE_END page 3

PAGE_BEG page 2

PAGE_END page 2

PAGE_BEG page 6

The current page pointer will next be reset to the newly created page 6. The current path would now look like the following:

page 1: URL=a, referrer=www.yahoo.com

page 2: URL=b, referrer=a

page 6: URL=f, referrer=b←current page pointer

Note that traversing up the path and finding a matching referrer causes the path to be trimmed at that point. Scanning stops once a new match is found.

The fourth scan type of a path starts from the current page pointer location and scans forward toward the end of the list for an occurrence of a URL that matches the new request's referrer. If the page is found in the path then a series of PAGE_END and PAGE_BEG events are generated until the page in the path is active. The found page is deactivated (PAGE_END) and the new page is activated (PAGE_BEG).

For the new request: URL=f, referrer=d Current path:

page 1: URL=a, referrer=www.yahoo.com

page 2: URL=b, referrer=a

page 3: URL=c, referrer=b←current page pointer

page 4: URL=d, referrer=c

page 5: URL=e, referrer=d

In this scenario the page pointer is not at the bottom of the path. The current active page for this path is page 3. The event generator 68 will find a match for the referrer at page 4 of the path. Accordingly, the following set of events will be generated:

PAGE END page 3

PAGE BEG page 4

PAGE END page 4

PAGE BEG page 6

The current page pointer would be reset to point to the newly created page 6. The current path would now look like the following:

page 1: URL=a, referrer=www.yahoo.com

page 2: URL=b, referrer=a

page 3: URL=c, referrer=b

page 4: URL=d, referrer=c

page 6: URL=f, referrer=d←current page pointer

Note that traversing down the path and finding a matching referrer causes the path to be trimmed at that point. Scanning stops once the match is found.

The fifth scan type of a path starts from the current page pointer location and scans backward toward the top of the list for an occurrence of a match between the new request's referrer and a referrer in the path. This scan is only performed if the ‘same referrer’ option is enabled when the event generator server is started. If the page is found in the path, a series of PAGE_END and PAGE_BEG events are generated until the page in the path is active. This option is available because some web servers will accept a request for a page as the directory, for example, /store/shoes/ and subsequently expand the request to be /stores/shoes/index.html because index.html is configured as the default page in the web server. This should only match the top URL of the path. Note that the found page is also removed from the list because the referrer, not the URL, was matched. An example of this scan type follows:

New request: URL=/a/index.htm, referrer=www.yahoo.com Current path:

page 1: URL=/a/, referrer=www.yahoo.com

page 2: URL=b, referrer=a

page 3: URL=c, referrer=b←current page pointer

page 4: URL=d, referrer=c

page 5: URL=e, referrer=d

In this scenario, the page pointer is not at the bottom of the path. The current active page for this path is page 3. The event generator 68 will find a match for the referrer at page 1 of the path. The following set of events will be generated.

PAGE_END page 3

PAGE_BEG page 2

PAGE_END page 2

PAGE_BEG page 1

PAGE_END page 1

PAGE_BEG page 6

The current page pointer would be reset to point to page 6. The current path and page would now be:

Page 6: URL=/a/index.htm, referrer=www.yahoo.com

Note that traversing up the path and finding a matching referrer causes the path to be trimmed at that point. Scanning stops once a match is found.

A sixth and final scan type envisioned by the present invention includes a scan type of a path that starts from the current page pointer location and simply adds the page at this point in the path. This only occurs if the “one path only” option is set within the event generator 68. The page will always be added to the path, and thus, there would never be more than one path per visitor. In this case, note that the current page pointer is set to point to the current path and the current path is trimmed at the point that the page is added to the path.

Other potential events which can be generated by the event generator 34 include: cartData, which associates a shopping carts with a visitor; CART_CREATE; CART_UPDATE; CART_ADD; and CART_DESTROY.

In addition, the event generator 68 institutes a timeout for each network source. The event generator 68 has a separate thread process for scanning the network sources to determine if any of the network sources has timed out. The timer thread wakes up every 30 seconds and scans the list of network sources to determine if any pages have expired.

A page is considered expired if it has been active for longer than the allowed time set by a user selectable option. If the page has been active for this long, then a PAGE_END event is generated for that page. Also, a PATH_END event is generated. If there are no more active paths for the network source, the network source is eliminated. As part of the clean up for a network source, a CART_DESTROY event is generated if there is an active cart for the network source. Finally, a NETSRC_END event is generated for the network source and the network source is removed from the list of network sources.

Utilizing the stream of events 76 provided by the event generator 68, the event distribution engine 72 will analyze each event and form a tree or path based on some commonality within each event, such as a unique visitor identifier or the like. In this way, the administrator can obtain information on a particular system activity, such as a specific visitor's actions.

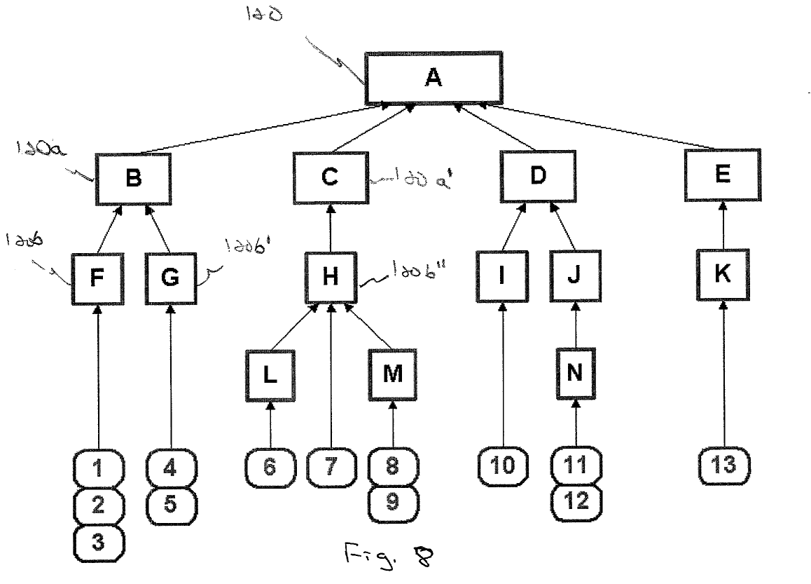

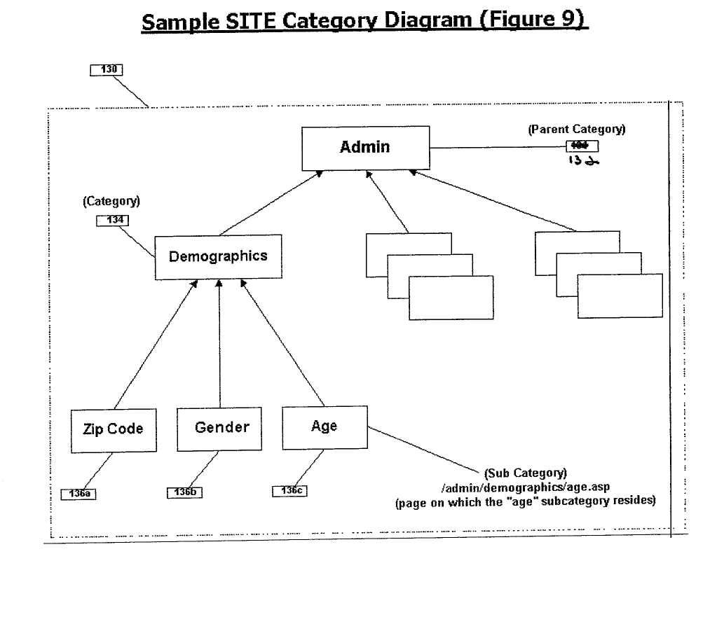

The event distribution engine 72 utilizes the event information received from the event generator 34 to create various “paths” 110, FIG. 7, out of each of the received events, since each of the received events have a unique visitor identifier. The developed “path” shows how the visitor entered the site and went from page to page until, finally, the visitor exited the site. The system will attempt to recreate page hits which are missing in an attempt to provide either a single path of a user's sequence or trail through the web site and/or to try to provide a link between two paths with the missing information.

Once the events have been grouped by the event distribution engine 72, they are stored, through a standard ODBC or other interface 78 in an event database 40 which may be resident on an event database server 80 or which may be part of the system server 60.

Ultimately, the events grouped by the event distribution engine 72 will be provided either directly, or through the event database 40, to the data accumulator 82. The data accumulator 82 uses these events to assemble and group visitor and system activity based upon both predefined and ad-hoc queries. The data accumulator 82 receives visitor information and cart information and creates useful, reportable statistics for the requesting party. The purpose of the data accumulator 82 is to dimensionalize a large amount of data, which heretofore was presented to the requesting party in a format that was not immediately useful.

The data accumulator may also have an optional trigger feature enabled. The trigger feature allows an administrative user to set one or more “events” as a trigger which will launch a real time action. The action can initiate a chat session; offer a customer a discount (for example if the customer is a repeat customer and has over $200.00 in his cart and on the checkout page); send a notification to the administrative user allowing the user to perhaps interact with the visitor (for example if the visitor has accessed a help page more than three (3) times; all in real time.

After a visitor leaves a web site, the visitor's trail becomes the center of inquiry by the web site administrator. Web site administrators wish to know how long the visitor spent on the site, the path that the visitor took while on the site, whether any product was placed in a shopping cart, whether any product was bought, or whether a shopping cart was abandoned with product in it.

Because administrator terminals 48 are typically running a web browser and communicate in HTTP requests over a TCP/IP link, the data accumulator 82 has no knowledge of how to interface with and support HTTP requests. Accordingly, the purpose of the data distributor 84 is to format the requests from the administrator terminal 48 to the data accumulator 82 and to receive information from the data accumulator 82 to the administrative terminal 48.

Additionally, once the data accumulator 82 receives the request from the data distributor 84, it will continue to send updated real time information to the data distribution module until the data distribution module tells the data accumulator 82 not to send any more information or until the data distribution module sees no further inquiries for certain data at which time it will tell the data accumulator 82 to stop sending the data.

The data distributor 84 receives the data from the data accumulator 82 and formats it for a graphical user interface, for use by one or more administrators at one or more administrative terminals 48. In response to the displayed information on the administrative terminal 48, the administrator may, using an input device such as a keyboard, mouse or the like 52, control the application process 26 in the web page 28 to be displayed to one or more visitors 16.

The data distributor module (DDM) 84 allows users located at administrative computer 48 to connect to the system using the HTTP 1.0 or HTTP 1.1 protocol. The most common application using these protocols are web browsers such as Microsoft's Internet Explorer and Netscape's Navigator. The DDM application does not require a persistent connection. It uses cookies to maintain a “session” between the user (e.g. web browser) and the system. When the user makes a request for specific real time statistics, the data may be returned in an XML stream or as an HTML page. All subsequent changes to the data are stored in the DDM until the users re-requests. The DDM is in effect maintaining a persistent connection to the DAC (Data Accumulator) server 82 on behalf of the user.

Accordingly, the data distributor 84, also preferably implemented as software acting as a CORBA client to the Data Accumulator 82, allows an administrative user to formulate requests to the accumulator 82 for real time statistics and information, and sends that information to the requesting party in an HTML format or as an XML stream. In this manner, the requesting party may monitor individual and summarized real-time web site activity. The information is presented graphically in such a way to promote intelligent user control and modification of the web site functionality (We need to note how to modify the web site—what is the connection).

Although the administrative user can set up different “filters” to get more focused information from the site, requests always deal with two primary pieces of information, namely visitors and category. For example, the user may want to gather information on specific visitors or specific visitor types that have been predefined or recently defined, or may want to gather information on a particular sequence, that is, the path through various categories that any visitor to the site might take.

The data distributor 84 allows the users at administrative terminals 48 to pre-configure the criteria for visitors, categories, or sequences that he or she wishes to view. Such sequences can be redefined, in real time, so as to allow the administrative user to see different information.

Possible visitor type configurations or filters include choosing visitors by referrer, cart value, and time criteria.

For example, a user may wish to track all visitors that came to the site from a particular referrer, such as Yahoo, Excite, or Lycos. Moreover, since every e-commerce site must have a way for a customer to collect the items for purchase until checkout, which is usually known as a shopping cart or cart, this filter allows the user to select a minimum cart value as part of a visitor-type configuration. Finally, the user may decide to track visitors by the amount of time that they spent on a page or the amount of time that they spent on a site.

The user may also define categories to monitor. On e-commerce sites, categories and subcategories reflect specific items on the web site. Categories are arranged in a hierarchy or “tree” from general categories to more specific categories. There can be virtually an unlimited number of categories and subcategories in an overall tree. It is important to remember that any given category can contain either one or more pages or one or more subcategories.

Pages are always the lowest level of any particular category/subcategory. A site category “tree” may have some branches with many levels of subcategories, and other branches that are “shallow”, and go directly to the page level. As the user “drills down” one level at a time, the user will continue to be in a subcategory until it reaches the lowest level of that subcategory where the pages reside.

An example of a parent category/subcategory tree, 130, is shown in FIG. 9. In this example, the admin block 132 is the “parent” category, with any number of different branches containing subcategories. Subcategory branch 134 entitled “demographics” is one of those branches. Since the subcategory “demographics” is not the lowest level of this category, it must contain one or more subcategories 136. As can be seen, there are several subcategories 136 under category 134. Further, since each of the three subcategories 136 are at their lowest level, each contains one or more pages. The page of the “age” subcategory 136c is referred to as “/admin/demographics/age.asp”. Each of the other lowest-level subcategories 136 under the “demographics” category 134 reflects the same general path with its own unique page, such as gender.asp, etc.

Accordingly, a user may decide to view a particular portion of the web site by category, and a user may add categories to be viewed by entering a category name, optional description and it's association with a parent category. The user has the full ability to add, modify, or delete a category and all its attributes.

A user may next establish, modify, and delete “page views”. Page views function almost identically to category views, however they use specific path information to identify a page to be monitored. Wildcards may be used so that an “*” may be used instead of a long URL path to enter the page or pages to be monitored or as part of a URL path such as /home/shop*.

Finally, a user may monitor sequences, which are defined as specific combinations of category visits. A combination of categories constitutes an activity sequence and allows a user to monitor how many visitors to the site followed each defined activity sequence. There are two ways in which a user can construct a sequence. An exact sequence can be constructed in which the user identifies each specific category in an exact order, one directly after the other. Alternatively, a user may define a flexible sequence in which wildcards are used within the overall sequence.

For example, for the sample web site of FIG. 10, the shopping category 140 is the first possible merchandize location on the site and all other locations are subcategories of the category 140. As the visitor travels down each tree, each branch 143 contains additional subcategories.

In one example, a user might construct a sequence using shopping as one of the categories in his or her request. If a web site visitor is in the men's apparel subcategory, the sequence criterion would be met and displayed to the user. However, the user may specify any category in a sequence, no matter how deep the subcategory may be in the overall tree. This gives the user tremendous flexibility since the user may be as specific or general in the sequences that he or she chooses.

Additionally, the present invention provides further flexibility in that the user can specify “exact” sequences by specifying categories in a particular order, one right after another, or “flexible” sequences using wild cards between specific categories. For example, if a user enters the exact sequence “home-shopping-apparel-womens-search”, this means that the user wishes to track visitors who enter the web site directly into home, then go somewhere in the shopping category, then go somewhere in the apparel category, then go somewhere in the womens category, then go into the search engine category.

On the other hand, a flexible sequence can be set up so that the visitor does not have to follow each identified category one directly after the other. The user can construct a sequence that does identify specific categories, but allows maximum flexibility about where the visitor goes on the entire web site between these categories. This flexibility is possible through the use of wild cards. Using a wildcard (“any”) between specific categories in a sequence actually means that the user does not care where the visitor goes between the specified categories.

For example, the sequence “any-shopping-flowers-gift certificates-any-shopping-any-check out” means that the user wishes to track:

visitors that come to the web site from any entry point;

then go somewhere in the shopping category;

then go somewhere in the flowers subcategory;

then go somewhere in the gift certificates subcategory;

then go to any place on the entire site, including shopping;

then go somewhere in the shopping category;

then go to any other place on the entire site;

and then to go to the check out.

Sequence descriptions can be added and named for future reference, and can be edited and/or deleted.

The result of all of the users tracking configurations is the ability to display data in a unique, graphical format.

FIG. 11 illustrates a display to a user of information regarding web site visitors wherein it is shown that the user, sitting at an administrative terminal 48, may display information by visitors 144. The data distributor 84 of the present invention allows the user to set several settings which will effect the display including how the display is ordered, 146 such as by total time on the site, ascending amount of the time, descending amount of time or the like. In addition, the display may also include information such as category, page or referrer, 148. The user is allowed to save both predefined visitor types for display 150 as well as saved sequences to display, 152.

The user window 143 provides a great deal of information about the visitor currently on the site being monitored by the user. It is not a passive display window, but rather certain parameters may be set which will determine how the visitor types will appear and how they will be monitored. Every feature that can be monitored can be set and used as a filter by the user to facilitate display to the user of the desired characteristics of visitors to the web site.

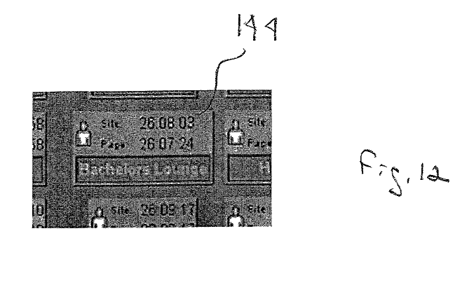

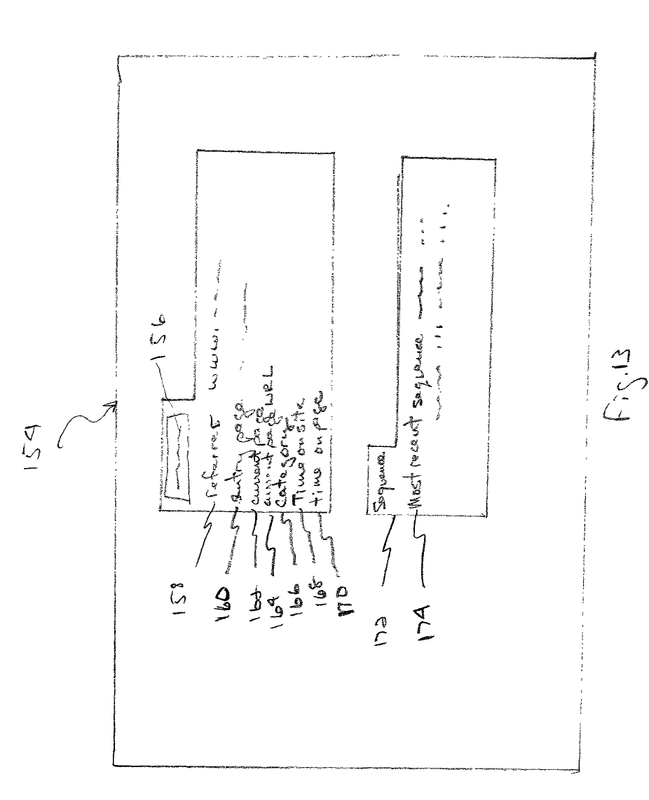

FIG. 12 illustrates one visitor display 144. If the user positions his or her cursor in the graphic display, the entire graphic display is a “hot spot” and a summary window 154, FIG. 13, is displayed which includes information such as the IP address or network host name (depending on the web servers configuration) 156; the referrer URL 158; the entry page into the web server 160; current page name 162; current page URL 164; category 166; time on site 168; and time on page 170. A second display 172 will show the different sequences that the visitor has traveled with the most recent sequence 174 identified.

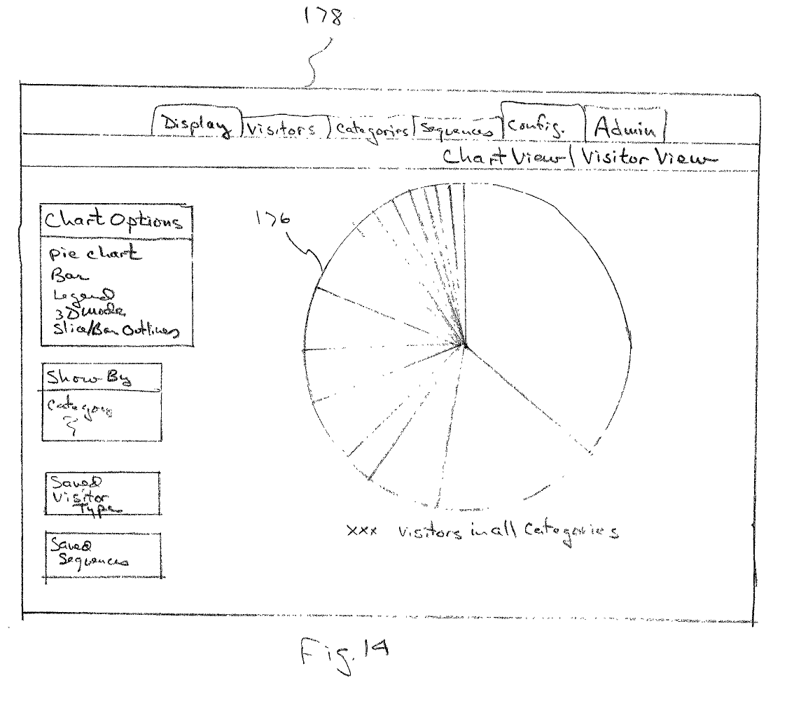

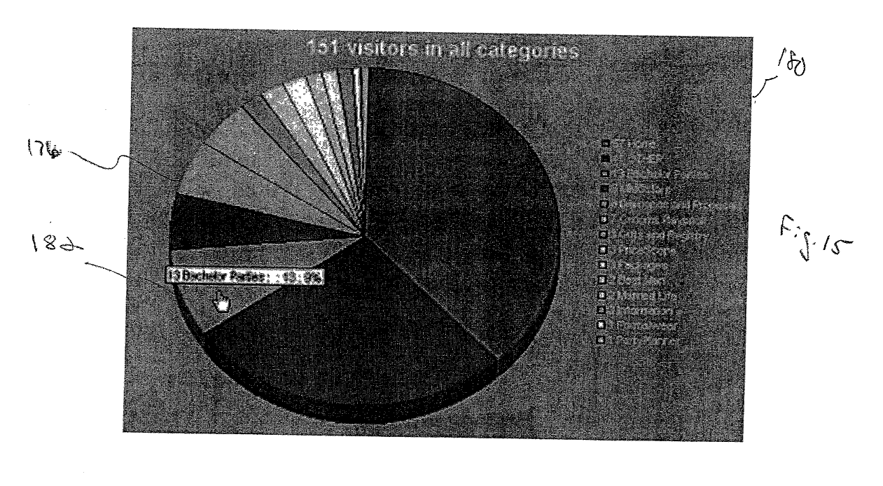

FIG. 14 illustrates the display of category information 176 in the form of a pie chart. The display categories window 178 presents a graphic display in the form of a pie chart, bar chart, legend, 3-D mode, and slice/bar outlines. The display/categories window has two different views namely chart view, shown in FIG. 14, and visitor view. In both views, the same real-time information is displayed, but in two different perspectives. The initial categories chart view window shows a top-level view 176 of all visitors in all of the first level categories currently in the web site. Users are able to examine these categories further by examining subcategories and pages tied to the subcategories. This is called drill-down. For example, if one looks at the category 182 entitled “bachelor parties”, there are thirteen visitors in this category at the present time.

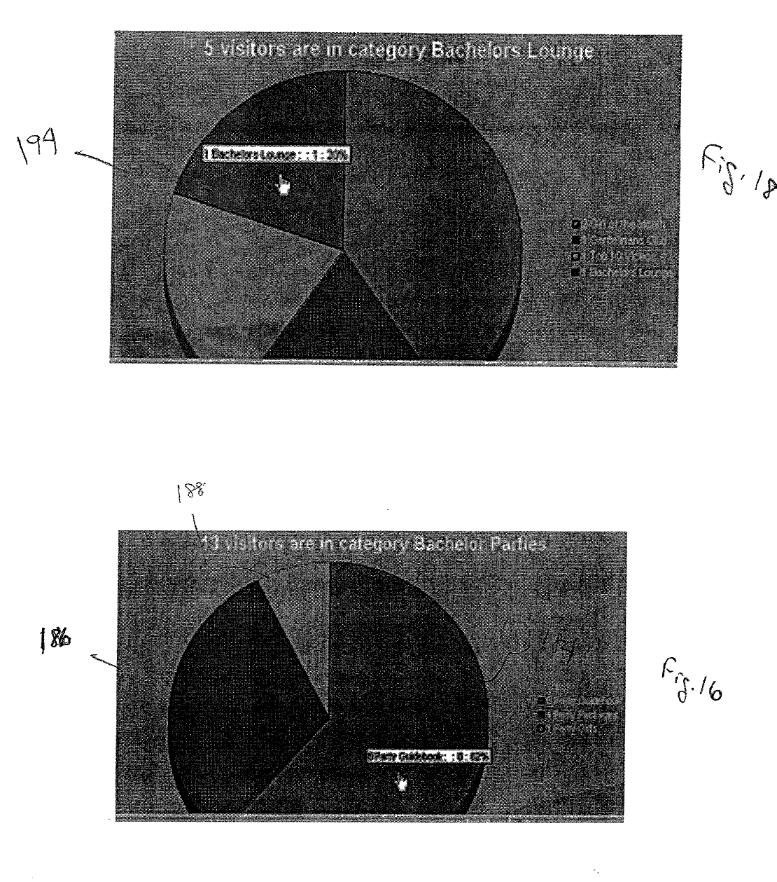

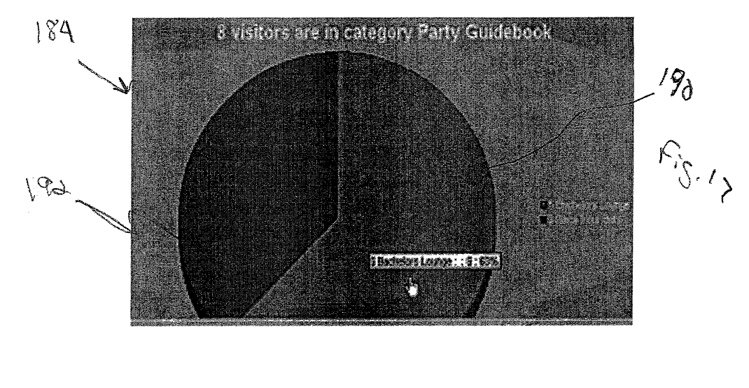

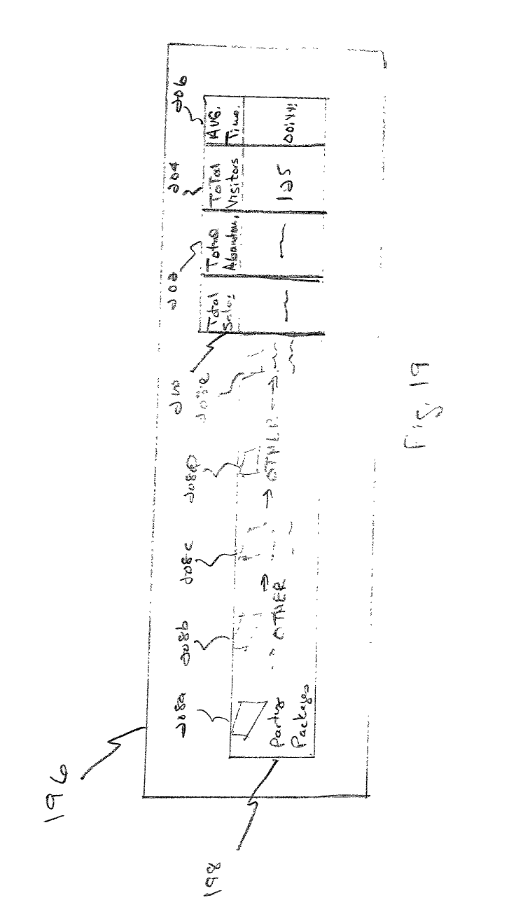

As shown in greater detail in FIG. 16, of these thirteen visitors, eight are in the subcategory “party quick book” 184; four are in the subcategory “party gifts” 186; and one visitor is in the “party gifts” 188. Double clicking on the desired subcategory will drill-down to the next level, as shown in FIG. 17 which shows a further breakdown of the eight visitors in the “party guide book” category 184 which includes five visitors in the “bachelors lounge”, subcategory 190, and three visitors in the “place your bets” subcategory 192. Double clicking yet again on the “bachelors lounge” subcategory 190 will result in drilling-down yet another level, FIG. 18, which indicates that there is one visitor in the selected subcategory “bachelors lounge” 194.

Double clicking on the “bachelors lounge” subcategory 194 will display visitor information as displayed at 144, FIG. 11. Thus, by toggling to the visitor view window as shown in FIG. 11, nearly identical information is provided with a different perspective. The visitor view window is extremely useful since it displays visitor information that matches the categories and page information in the chart view of FIG. 14. The user can toggle back and forth between the visitor views to monitor the activity on the web site as it is actually happening.

Yet a further display window is a sequence display window 196, FIG. 19, which allows the user to graphically view one or more predefined or presently defined sequences 198 which show the user information concerning visitors sequences; as well as other information including total sales 200 (in dollars); total abandoned sales (in dollars) 202; total numbers of visitors 204; and average time on the web site 206. By clicking on any of the individual categories in the sequence 208, the user can “drill-down” to a lower level to obtain information on any category or subcategory within the sequence.

Accordingly, the present invention provides a unique system and method for real-time monitoring of a server, such as a web server and providing normalized, grouped and useful real-time information to a user which can be used to both monitor the present status of a server, and to dynamically change the server to achieve better results.

Modifications and substitutions by one of ordinary skill in the art are considered to be within the scope of the present invention that is not to be limited except by the claims that follow.

The invention claimed is:

1. A system for performing real time monitoring of activities on an interactive network server, the system comprising:
an interactive network server including a source of information, an information controller and a server activity reporter, said interactive network server coupled to a computer network, for receiving requests for at least first information from at least one visitor accessing said interactive network server, and responsive to said requests, for providing said at least first information from said source of information to said visitor over said computer network, said information controller for controlling said providing of said at least first information to said at least one visitor, and said server activity reporter for providing an indication of at least some of said activities on said interactive network server;
a data filter, responsive to said interactive network server activity reporter, for filtering at least some of said interactive network server activity information and for providing filtered interactive network server activity information;
a data analyzer, responsive to said filtered interactive network server activity information, for determining at least the present status of said at least one visitor accessing said interactive network server;
a data reporter, responsive to said data analyzer and to a request for visitor information, for organizing and preparing for display, in a graphical format, at least said present status of said at least one visitor accessing said interactive network server; and
at least one network server administrative terminal including a data display device and a data input device, said at least one network server administrative terminal providing a request for visitor information to said data reporter, and responsive to said data reporter, for displaying, on said data display device, said at least present status of said at least one visitor in graphical format.

2. The system of claim 1 wherein said information controller is responsive to an information control signal, for controlling said providing of said at least first information to said at least one visitor.

3. The system of claim 2 wherein said data input device of said at least one network server administrative terminal provides said information control signal.

4. The system of claim 1 wherein said data filter is responsive to a data filter input file, and wherein said user input device from said at least one network server administrative terminal establishes said data filter input file.

5. The system of claim 4 wherein said data filter input file establishes desired visitor information which will be used to generate real time graphical reports.

6. The system of claim 5 wherein said desired visitor information is based on visitor activity on said interactive network server.

7. The system of claim 1 wherein graphical format is selected from the group consisting of a pie chart and a bar chart.

8. The system of claim 1 wherein said graphical format includes at least visitor information arranged in at least one format selected from the group consisting of a visitor format, a category format and a sequence format.

9. The system of claim 1 wherein said interactive network server includes at least one interactive web site server.

10. The system of claim 9 wherein said visitor information displayed in a graphical format includes the amount of time the visitor has been on the interactive web site server, the amount of time the visitor has been on a given web page and a category description of the given web page.

11. The system of claim 9 wherein said Internet web site server includes a plurality of Internet web site servers coupled together to act as one Internet web site server.

12. The system of claim 1 wherein said computer network includes the World-Wide-Web.

13. The system of claim 1 wherein said at least first information includes at least one web page provided from said interactive network server to said at least one visitor.

14. The system of claim 1 wherein said interactive network server receives a plurality of requests for a plurality of information from said at least one visitor.

15. The system of claim 1 further including:
a visitor information log, responsive to said at least one visitor accessing said interactive network server, for recording visitor information generally in real time, as said visitor information is generated, said recorded visitor information including at least a visitor identifier for each visitor accessing said interactive network server, said at least first information requested by said at least one visitor, and at least said first information provided by said interactive network server; and
a data parser, responsive to said visitor information, for organizing said recorded visitor information according to at least individual visitors accessing said interactive network server.

16. The system of claim 15 wherein said visitor identifier stored in said visitor information log includes an IP address.

17. The system of claim 1 wherein said interactive network server provides at least second information to said visitor, said at least second information not requested by said visitor.

18. The system of claim 1 wherein said visitor information includes the URL of web pages which said at least one visitor has accessed on the interactive network server.

19. The system of claim 6 wherein said visitor information further includes shopping cart contents.

20. The system of claim 15 wherein said data parser organizes said reported visitor information according to at least one individual visitor and in chronological order according to said at least one individual visitor.

21. The system of claim 1 wherein said data analyzer determines, in addition to the present status of said at least one visitor, the past history of said at least one visitor during said at least one visitor's present access to said interactive network server.

22. The system of claim 2 wherein said data analyzer further includes a data trigger, responsive to a user entered trigger value for at least one specific event, for generating a real time action response.

23. A system for performing real time monitoring of activities on a web server, the system comprising:
a web server including a source of a plurality of web pages, a web server controller and a web server activity reporter, said web server coupled to the world-wide-web, for receiving requests for at least a first web page from at least one visitor accessing said web server, and responsive to said requests, for providing said at least one web page from said source of said plurality of web pages to said visitor over said world wide web, said information controller for controlling said providing of said at least one web page to said at least one visitor, and said web server activity reporter for providing an indication of at least activities of said at least one visitor accessing said web server;
a data filter, responsive to said web server activity reporter, for filtering at least some of said web server activity information and for providing filtered web server activity information;
a data analyzer, responsive to said filtered web server activity information, for determining at least the present status of said at least one visitor accessing said web server;
a data reporter, responsive to said data analyzer and to a request for visitor information, for organizing and preparing for display, in a graphical format and in real time, at least said present status of said at least one visitor accessing said web server; and
at least one web server administrative terminal including a data display device and a data input device, said at least one web server administrative terminal providing a request for visitor information to said data reporter, and responsive to said data reporter, for displaying, on said data display device, said at least present status of said at least one visitor in graphical format.
